(19) United States
(12) Patent Application Publication
(10) Pub. No.: US 2017/0034694 A1
(43) Pub. Date: Feb. 2, 2017

(54) Systems and Methods of Serial Port Enumeration for Multi-Subscription Multi-Standby Communication Devices

(71) Applicant: QUALCOMM Incorporated, San Diego, CA (US)

(72) Inventors: Tirumala Rama Rao Kollu, Hyderabad (IN); Uday Kumar Arava, Hyderabad (IN); Manu Gautam, Hyderabad (IN)

(21) Appl. No.: 14/809,360

(22) Filed: Jul. 27, 2015

(51) Int. Cl. H04W 8/26; H04W 4/00

(52) U.S. Cl. CPC H04W 8/265; H04W 4/001; H04W 88/06

(57) ABSTRACT

Embodiments include systems and methods of serial port enumeration for communication via a multi-subscription multi-standby communication device. A processor of a computing device in communication with the multi-subscription multi-standby communication device may associate each of two or more serial ports of the computing device with a different subscription of the multi-subscription multi-standby communication device. The processor of the computing device may send communications to a subscription of the multi-subscription multi-standby communication device by addressing the communications to the serial port associated with the subscription.

### BACKGROUND

A mobile communication device that includes two or more subscriber identity module cards may communicate with two or more different mobile communication networks using one or more separate radio frequency (RF) communication circuits. A subscriber identification module (also referred to as a “SIM” or “SIM card”) is a memory device, such as an integrated circuit embedded into a removable card, that may store a subscriber identifier (e.g., an International Mobile Subscriber Identity) and/or other information that may be used to identify and/or authenticate a wireless device on a communication network and enable a mobile communication device to communicate with a communication network. A mobile communication device that includes two or more SIMs may be termed a “multi-subscription multi-standby communication device.” A multi-subscription multi-standby communication device can be configured to provide services and other communication capabilities that are unavailable to a communication device supporting a single SIM. For example, a multi-subscription multi-standby communication device can be configured to provide simultaneous services in more than one domain, such as simultaneous Global System for Mobile Communications (GSM) and 3GPP Long Term Evolution (LTE) (e.g., SGLTE), simultaneous Voice and LTE (e.g., SVLTE), and the like, with two radio protocol stacks per subscription.

A processor of a multi-subscription multi-standby communication device may address a modem of the multi-subscription multi-standby communication device using an attention (AT) command to issue commands and access information needed to control a radio protocol stack of the modem, including radio access technology (RAT) information, signal level information (such as received signal strength information), network registration information, and other similar information. The modem may provide information about an event, or a response to a query, in an unsolicited result code (URC).

Certain mobile communication devices may be configured to permit another device to use the network communication capabilities of the mobile communication device to communicate with a communication network. For example, when another computing device, such as a personal computer or an automotive entertainment system head unit, is connected with a multi-subscription multi-standby communication device using a physical connection (e.g., a USB cable), the computing device may use the cellular communication capabilities of the multi-subscription multi-standby communication device. However, the connected computing device may only enumerate a single communication port with the multi-subscription multi-standby communication device, and the connected computing device may be unable to issue commands to or access information from a modem of the multi-subscription multi-standby communication device that are specific to one of the subscriptions of the multi-subscription multi-standby communication device.

### SUMMARY

Systems, methods, and devices of various embodiments enable a computing device to perform serial port enumeration for communication via a multi-subscription multi-standby communication device executed by a processor of the computing device in communication with the multi-subscription multi-standby communication device. Various embodiments may include associating each of two or more serial ports of the computing device with a different subscription of the multi-subscription multi-standby communication device, and sending communications to a subscription of the multi-subscription multi-standby communication device by addressing the communications to the serial port associated with the subscription.

In some embodiments, associating each of two or more serial ports of the computing device with a different subscription of the multi-subscription multi-standby communication device may include sending to the multi-subscription multi-standby communication device a configuration query, receiving a configuration value from the multi-subscription multi-standby communication device in response to the configuration query, in which the configuration value may include a type of subscriptions of the multi-subscription multi-standby communication device. In various embodiments, the configuration value may include at least one of voice subscriptions and data subscriptions. In some embodiments, associating each of two or more serial ports of the computing device with a different subscription of the multi-subscription multi-standby communication device may include associating each of two or more serial ports of the computing device with a different subscription of the multi-subscription multi-standby communication device based on the configuration value.

In some embodiments, associating each of two or more serial ports of the computing device with a different subscription of the multi-subscription multi-standby communication device may include sending to the multi-subscription multi-standby communication device a subscription query, receiving a subscription value from the multi-subscription multi-standby communication device in response to the subscription query, wherein the subscription value may include a number of subscriptions of the multi-subscription multi-standby communication device. In some embodiments, the subscription value may include at least one of a number of voice subscriptions and a number of data subscriptions of the multi-subscription multi-standby communication device. In some embodiments, associating each of two or more serial ports of the computing device with a different subscription of the multi-subscription multi-standby communication device may include associating each of two or more serial ports of the computing device with a different subscription of the multi-subscription multi-standby communication device based on the subscription value.

In some embodiments, sending communications to a subscription of the multi-subscription multi-standby communication device by addressing the communications to the serial port associated with the subscription may include selecting a subscription of the multi-subscription multi-standby communication device using the association of serial ports of the computing device to subscriptions of the multi-subscription multi-standby communication device in response to receiving a communication command from client software of the computing device. In some embodiments, sending communications to a subscription of the multi-subscription multi-standby communication device by addressing the communications to the serial port associated with the subscription may include sending an instruction to establish a communication session using a subscription of the multi-subscription multi-standby communication device by addressing the communications to the serial port associated with the subscription. Some embodiments may further include receiving communications from the multi-subscription multi-standby communication device according to a communication session conducted by the multi-subscription multi-standby communication device via the serial port associated with the subscription.

Various embodiments may include a computing device including a processor configured with processor-executable instructions to perform operations of the embodiment methods described above. Various embodiments may include a non-transitory processor-readable storage medium having stored thereon processor-executable software instructions configured to cause a processor to perform operations of the embodiment methods described above. Various embodiments may include a computing device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention, and not to limit the disclosed embodiments.

FIG. 1 is a component block diagram illustrating a communication system suitable for use with various embodiments.

FIG. 2 is a component block diagram illustrating a multi-subscription multi-standby communication device according to various embodiments.

FIG. 3 is a component block diagram illustrating communication between a computing device and a multi-subscription multi-standby communication device according to various embodiments.

FIG. 4A is a table illustrating exemplary configuration values according to the various embodiments.

FIG. 4B is a table illustrating an exemplary subscription configuration according to the various embodiments.

FIG. 4C is an exemplary information display of enumerated serial ports and related descriptions according to the various embodiments.

FIG. 5 is a process flow diagram illustrating a method of serial port enumeration for communication via a multi-subscription multi-standby communication device according to various embodiments.

FIG. 6 is a component block diagram of a mobile communication device suitable for implementing various embodiments.

FIG. 7 is a component block diagram of a computing device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and systems that enable a computing device to communicate via specific subscriptions of a multi-subscription multi-standby communication device by addressing communications to a serial port associated with a specific subscription.

The terms “communication device,” “mobile device,” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices which include a programmable processor and a memory. Various embodiments may be useful in mobile communication devices, such as smart phones, cellular telephones and other portable computing platforms. Various embodiments may be particularly useful in any communication devices that use radio protocol stacks to communicate with a communication network under a subscription.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A multi-subscription multi-standby communication device may be configured to provide services and other communication capabilities that are unavailable to a communication device supporting a single SIM. For example, a multi-subscription multi-standby communication device may be configured to provide simultaneous services in more than one domain, such as SGLTE, SVLTE, and other similar domains, with two radio protocol stacks per subscription. Examples of multi-subscription multi-standby communication devices include a Dual SIM Dual Standby (DSDS) communication device in which two SIMs can use one radio, a Dual SIM Dual Active (DSDA) device in which two SIMs can use two radios, a Triple SIM Triple Standby (TSTS) device in which three SIMs use one or two radios, Simultaneous GSM and LTE+GSM DSDS (SGLTE+G), Simultaneous Voice and LTE+GSM DSDS (SVLTE+G), and/or the like.

Multi-subscription multi-standby communication devices may include two (or more) radios, which may use different access technology (RAT) protocols, and may use two or more RAT protocol stacks within a single subscription. Thus, modern multi-SIM communication devices can support a wide range of communication technologies and configurations. Examples of RATs include cellular communication technologies, such as you will GSM, LTE, LTE-Advanced, Code Division Multiple Access (CDMA), Time Division Multiple Access (TDMA), Wideband Code Division Multiple Access (WCDMA), Worldwide Interoperability For Microwave Access (WiMAX), and Universal Mobile Telecommunications System (UMTS). RATs may also include other wireless communications protocols, such as IEEE 802.11 (Wi-Fi), IEEE 801.15.1 (Bluetooth), IEEE 802.15.3 (UWB), and IEEE 802.15.4 (ZigBee).

A mobile communication device modem may be accessed or commanded through an AT command. AT commands are used to send instructions and request information needed to control a radio protocol stack of the modem, including RAT information, signal level information (such as received signal strength information), network registration information, and other similar information. A modem may provide information about an event, or a response to a query, in a URC. A multi-subscription multi-standby communication device may include two (or more) radio protocol stacks per subscription, and such devices may be configured to issue commands to and obtain information from specific subscriptions and/or RAT protocol stacks.

Certain mobile communication devices may be configured to permit another device to use the network communication capabilities of the mobile communication device to communicate with a communication network. For example, when another computing device, such as a personal computer or an automotive entertainment system head unit, is connected with a multi-subscription multi-standby communication device using a physical connection (e.g., a USB cable or another physical connector), the computing device may use the cellular communication capabilities of the multi-subscription multi-standby communication device. However, the connected computing device may only enumerate a single communication port with the multi-subscription multi-standby communication device, and the connected computing device may be unable to issue commands to or access information from a modem of the multi-subscription multi-standby communication device that are specific to one of the subscriptions of the multi-subscription multi-standby communication device.

The various embodiments enable a computing device to enumerate serial ports of the computing device such that each of two or more serial ports of the computing device may be associated with a different subscription of the multi-subscription multi-standby communication device. The computing device may then send communications to a specific subscription of the multi-subscription multi-standby communication device by addressing the communications to the serial port associated with the specific subscription. The computing device may also issue commands to and obtain information from specific subscriptions and/or RAT protocol stacks.

In various embodiments, a processor of the computing device may enumerate one or more virtual serial ports to provide specific serial port addresses that the processor of the computing device may use to address communications to a specific subscription of the connected multi-subscription multi-standby communication device. The subscriptions of the multi-subscription multi-standby communication device may include voice subscriptions and/or data subscriptions associated with one or more communication networks. In various embodiments, the processor of the computing device may receive from a modem of the multi-subscription multi-standby communication device an indication of the type of subscriptions of the multi-subscription multi-standby communication device. The processor of the computing device may receive from the modem of the multi-subscription multi-standby communication device an indication of a number of subscriptions of the multi-subscription multi-standby communication device. The processor of the computing device may use the indication of the type and/or number of the subscriptions of the multi-subscription multi-standby communication device to enumerate serial ports of the computing device.

In various embodiments, a serial port driver of the computing device, such as a USB driver, may use the enumerated virtual serial ports to address communications and/or commands to the multi-subscription multi-standby communication device modem. In various embodiments, an enumerated serial port may be dedicated to a subscription of the multi-subscription multi-standby communication device. In various embodiments, the processor of the computing device may assign each enumerated serial port an identifier to indicate its associated subscription of the multi-subscription multi-standby communication device. The processor of the computing device may use the assigned serial port identifiers to conduct communications and/or issue commands specific to a protocol stack on the multi-subscription multi-standby communication device.

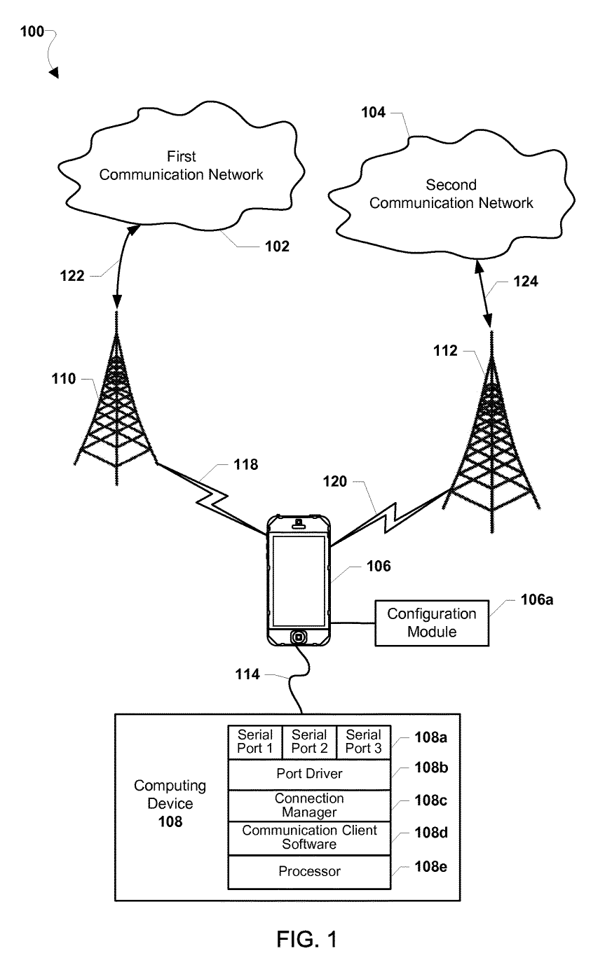

Various embodiments may be implemented in wireless communication devices that may operation within a variety of communication systems 100, particularly systems that include at least two communication networks, an example of which is illustrated in FIG. 1. A first communication network 102 and a second communication network 104 typically include a plurality of cellular base stations (e.g., a first base station 110 and a second base station 112). A multi-subscription multi-standby communication device 106 may be in communication with the first communication network 102 through a communication link 118 (e.g., a cellular connection) to the first base station 110. Additionally, or alternatively, the first communication device 106 may also be in communication with the second communication network 104 through a communication link 120 to the second base station 112. The first base station 110 may be in communication with the first communication network 102 over a wired or wireless communication link 122, which may include fiber optic backhaul links, microwave backhaul links, and other similar communication links. The second base station 112 may be in communication with the second communication network 104 over a wired or wireless communication link 124 similar to the communication link 122. In various embodiments, the first and second communication networks may include mobile telephony communication networks. In various embodiments, the communication links 118 and 120 may include cellular connections that may be made through two-way wireless communication links using a wireless communication protocol such as GSM, LTE, WiMAX, CDMA, TDMA, WCDMA, and other communication protocols. While the communication links 118 and 120 are illustrated as single links, each of the communication links may include a plurality of frequencies or frequency bands, each of which may include a plurality of logical channels. Additionally, each of the communication links 118 and 120 may utilize more than one RAT.

The multi-subscription multi-standby communication device 106 may be associated with one or more subscriptions to enable access to the first and/or second communication networks 102 and 104. For example, for a communication device including a dual-SIM-dual-stack architecture, two registrations to two different wireless networks may be allowed. The dual stack architecture may emulate having two different modems allowing for two different network registrations.

The multi-subscription multi-standby communication device 106 may be configured to permit a computing device 108 to use the network communication capabilities of the mobile communication device to communicate with a communication network. In various embodiments, the multi-subscription multi-standby communication device may include a configuration module 106a, which may provide information about subscriptions that are available on the multi-subscription multi-standby communication device to the computing device 108.

The computing device 108 may include a standalone computing device, such as a personal computer or other computing platform, where the computing device 108 may include a computing device integrated into a larger system, such as an automotive entertainment system head unit (e.g., an infotainment system) or another integrated computing device. The computing device may be connected to the multi-subscription multi-standby communication device using a physical connector 114, which may conform to one or more standards/protocols, such as but not limited to USB, IEEE 1394, PS/2, DVI, and HDMI.

The computing device 108 may communicate with the multi-subscription multi-standby communication device via one or more serial ports 108a, which the computing device 108 may enumerate to determine an address, an identifier, or other means of addressing communications to each serial port 108a. The computing device 108 may include a port driver 108b, which may include hardware and/or software to control the operation of the one or more serial ports 108a. The computing device 108 may further include a connection manager 108c, which may include hardware and/or software that may communicate with the port driver 108b, and which may be configured to manage communications with, among other things, the multi-subscription multi-standby communication device 106. Further, the computing device 108 may include communication client software 108d, which may be executed on a processor 108e of the computing device 108 and may be used to perform communications activities, such as voice communications and/or data communications. For example, while the computing device 108 and the multi-subscription multi-standby communication device 106 are connected, the computing device 108 may use the cellular communication capabilities of the multi-subscription multi-standby communication device 106 to conduct, for example, a voice communication session and/or a data communication session.

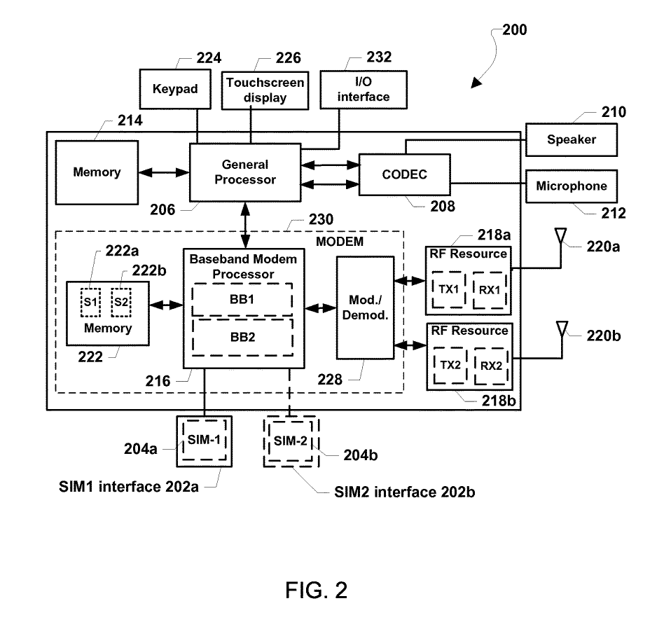

FIG. 2 is a component block diagram of a multi-subscription multi-standby communication device 200 suitable for implementing various embodiments. In various embodiments, the multi-subscription multi-standby communication device 200 may be similar to the multi-subscription multi-standby communication device 106 as described with reference to FIG. 1.

With reference to FIGS. 1 and 2, the multi-subscription multi-standby communication device 200 may include a first SIM interface 202a, which may receive a first identity module SIM-1 204a that is associated with a first subscription. The multi-subscription multi-standby communication device 200 may optionally also include a second SIM interface 202b, which may receive a second identity module SIM-2 204b that is associated with a second subscription. The multi-subscription multi-standby communication device 200 may optionally include additional SIM interfaces (not illustrated) that may be substantially similar to the first and second SIM interfaces 202a, 202b, and which may receive an identity module substantially similar to the first and second identity modules 204a, 204b.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a central processor unit (CPU), read only memory (ROM), random access memory (RAM), electrically erasable programmable memory (EEPROM) and input and output (I/O) circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general purpose processor 206, which may be coupled to a coder/decoder (CODEC) 208. The CODEC 208 may be coupled to a speaker 210 and a microphone 212. The general purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use a baseband-RF resource chain. Each baseband-RF resource chain may include the baseband modem processor 216 to perform baseband/modem functions for communicating with/controlling a RAT, and one or more amplifiers and radios, referred to generally herein as RF resources. In various embodiments, baseband-RF resource chains may share a common baseband modem processor 216 (i.e., a single device that performs baseband/modem functions for all RATs on the multi-subscription communication device). Alternatively, each baseband-RF resource chain may include the physically or logically separate baseband processors (e.g., BB1, BB2).

The RF resources 218a, 218b may be transceivers associated with one or more RATs and may perform transmit/receive functions for the multi-subscription multi-standby device 200 on behalf of their respective RATs. The RF resources 218a, 218b may include separate transmit and receive circuitry. In various embodiments, the RF resource 218b may include only receive circuitry. The RF resources 218a, 218b may each be coupled to a wireless antenna (e.g., a first wireless antenna 220a and a second wireless antenna 220b). The RF resources 218a, 218b may also be coupled to the baseband modem processor 216.

In various embodiments, the general purpose processor 206, memory 214, baseband processor(s) 216, and the RF resources 218a, 218b may be included in the mobile communication device 200 as a system-on-chip. In various embodiments, the first and second SIMs 204a, 204b and their corresponding interfaces 202a, 202b may be external to the system-on-chip.

Further, various input and output devices may be coupled to components on the system-on-chip, such as interfaces or controllers, for example, I/O interface 232. In various embodiments, the I/O interface may be connected and may communicate via physical connection (e.g., the connector 114) to another device, such as the computing device 108. Example user input components suitable for use in the mobile communication device 200 may include, but are not limited to, a keypad 224 and a touchscreen display 226.

In various embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription communication device 200 to enable communication between them.

Functioning together, the two SIMs 204a, 204b, the baseband processor(s) 216, the RF resources 218a, 218b and the antennas 220a, 220b may enable communications on two or more RATs. For example, one SIM, baseband processor, and RF resource may be configured to support two different RATs. In other embodiments, more RATs may be supported on the multi-subscription communication device 200 by adding more SIM cards, SIM interfaces, RF resources, and antennas for connecting to additional mobile networks.

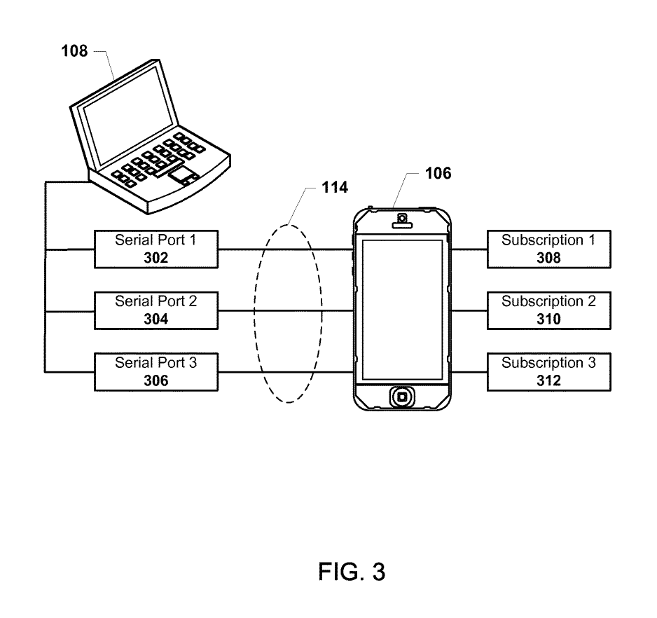

FIG. 3 is a component block diagram of a computing device and a multi-subscription multi-standby communication device according to various embodiments. In various embodiments, the computing device 108 may be similar to the computing device 108 as described with reference to FIG. 1. The multi-subscription multi-standby communication device 106 may be similar to the multi-subscription multi-standby communication device 106 as described with reference to FIG. 1 and/or the multi-subscription multi-standby communication device 200 as described with reference to FIG. 2.

With reference to FIGS. 1-3, a processor of the computing device 108 may enumerate one or more serial ports 302, 304, 306 to enable the computing device to communicate with a communication device, such as the multi-subscription multi-standby communication device 106. In various embodiments, the processor 108e of the computing device 108 may enumerate one or more virtual serial ports to provide specific serial port addresses or identifiers, which the processor 108e of the computing device 108 may use to address communications to the multi-subscription multi-standby communication device 106. For example, the processor 108e of the computing device 108 may enumerate one or more virtual serial ports and may use determined serial port addresses or identifiers to direct communications and/or commands to a specific subscription of the connected multi-subscription multi-standby communication device 106. In various embodiments, the computing device processor 108e may enumerate the one or more serial ports in response to determining that the computing device 108 and the multi-subscription multi-standby communication device 106 are connected via the connector 114.

The multi-subscription multi-standby communication device 106 may be associated with multiple subscriptions 308, 310, 312 that enable the multi-subscription multi-standby communication device 106 to communicate with two or more communication methods. For example, subscription 1 (308) may enable the multi-subscription multi-standby communication device to conduct a voice communication session over a first communication network (e.g., 102), and subscription 2 (310) may enable the multi-subscription multi-standby communication device to conduct a voice communication session over a second communication network (e.g., 104). Additionally, or alternatively, a subscription, such as subscription 3 (312) may enable the multi-subscription multi-standby communication device 106 to conduct a data communication session over the first or second communication network 102, 104, or over a third communication network. The subscriptions may be associated with one or more SIM cards, such as SIMs 204A, 204B.

The processor of the computing device 108 may associate each of the serial ports 302, 304, 306, with one of the subscriptions 308, 310, 312. For example, the processor of the computing device 108 may associate serial port 1 (302) with subscription 1 (308), serial port 2 (304) with subscription 2 (310), and serial port 3 (306) with subscription 3 (312). In some embodiments, the processor of the computing device 108 may associate the serial ports with the subscriptions as part of or related to a process of serial port enumeration.

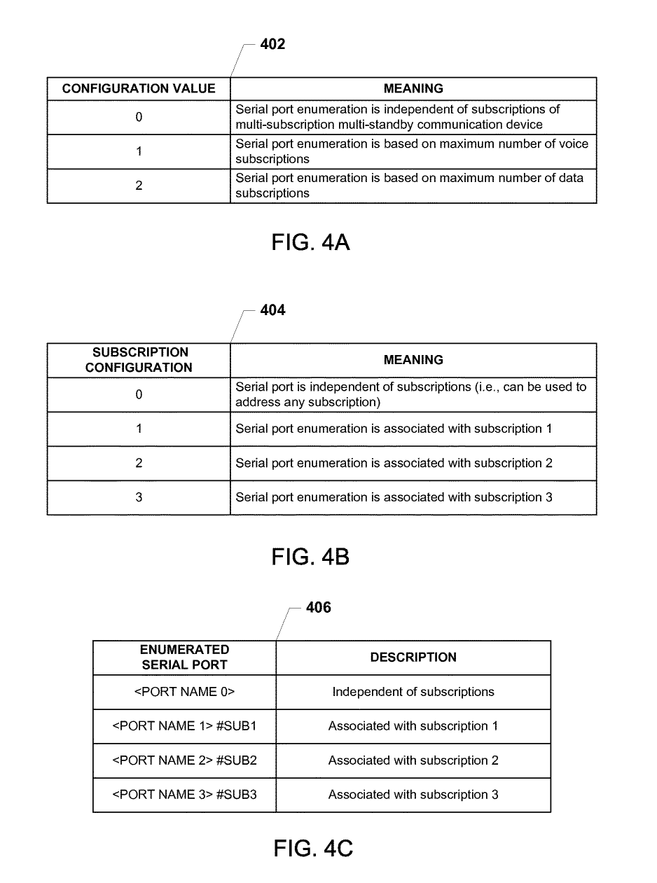

FIG. 4A illustrates an example table 402 of configuration values according to the various embodiments. In various embodiments, a multi-subscription multi-standby communication device (e.g., the multi-subscription multi-standby communication device 106, 200 of FIGS. 1-3) may send one or more configuration values to a computing device (e.g., such as the computing device 108 of FIGS. 1 and 3) when the computing device and the multi-subscription multi-standby communication device are connected by a connector (e.g., the connector 114 of FIG. 1). The computing device may perform serial port enumeration using the one or more configuration values from the multi-subscription multi-standby communication device.

With reference to FIGS. 1-4A, the multi-subscription multi-standby communication device may provide to the computing device an indication of the types of subscriptions of the multi-subscription multi-standby communication device. In various embodiments, the computing device may send a query to the multi-subscription multi-standby communication device to request information regarding the types of subscriptions that the multi-subscription multi-standby communication device can support.

In various embodiments, the information provided by the multi-subscription multi-standby communication device may include one or more configuration values. For example, a configuration value of 1 may indicate that the computing device should perform serial port enumeration based on a number (e.g., a maximum number) of voice subscriptions of the multi-subscription multi-standby communication device. As another example, a configuration value of 2 may indicate that the computing device should perform serial port enumeration based on a number (e.g., a maximum number) of data subscriptions of the multi-subscription multi-standby communication device. As a further example, a configuration value of 0 may indicate that the computing device should perform serial port enumeration independent (i.e., without consideration of, or without using information about) subscriptions of the multi-subscription multi-standby communication device. Other configuration values are also possible, such as a configuration value (e.g., 3) that may indicate that the computing device should perform serial port enumeration based on a first number of voice subscriptions and a second number of data subscriptions of the multi-subscription multi-standby communication device.

The various configuration values may reflect the capabilities of a particular mobile communication device architecture. For example, a dual-subscription dual-standby (DSDS) communication device may be configured to support two subscriptions (e.g., with two SIMs) communicating with two communication networks, but only conduct one data communication session at a time using a single shared RF resource (i.e., if a first data communication session is active, the DSDS communication device is unable to initiate a second concurrent data communication session until there is a break in the first data communication session). As another example, a dual-subscription dual-active (DSDA) communication device (e.g., the multi-subscription multi-standby communication device 200) may also be configured with subscriptions to two communication networks, and further may be configured to conduct two concurrent (i.e., dual active) data communication sessions using two RF resources 218a, 218b as described.

In various embodiments, the multi-subscription multi-standby communication device may also send to the computing device information regarding the number of subscriptions of the multi-subscription multi-standby communication device, such as at least one of a number of voice subscriptions and a number of data subscriptions. For example, the computing device may send to the multi-subscription multi-standby communication device a subscription query, and in response the multi-subscription multi-standby communication device may send to the computing device a subscription value. The subscription value may include at least one of a number of voice subscriptions and a number of data subscriptions of the multi-subscription multi-standby communication device. The computing device may perform serial port enumeration based on the subscription value.

FIG. 4B illustrates an exemplary subscription configuration 404 according to the various embodiments. The subscription configuration of FIG. 4B may be a data structure organized in a variety of manners, and stored in a memory of a computing device, such as the computing device 108 of FIG. 1.

With reference to FIGS. 1-4B, the computing device may perform serial port enumeration of physical and/or virtual serial ports, which may be based on a configuration value and/or a subscription value received by the computing device from the multi-subscription multi-standby communication device. During or after the serial port enumeration, the computing device may associate each of the serial ports of the computing device with a subscription of the multi-subscription multi-standby communication device.

The computing device may also generate a data structure such as the subscription configuration 404, which includes a subscription configuration value and a corresponding association of a subscription of the multi-subscription multi-standby communication device with a serial port of the computing device. For example, a subscription configuration value of 1 may indicate that a first communication device serial port (e.g., serial port 1 (302)) is associated with a first subscription (e.g., subscription 1 (308)). As another example, a subscription configuration value of 2 may indicate that a second communication device serial port (e.g., serial port 2 (304)) is associated with a second subscription (e.g., subscription 2 (310)). As a further example, a subscription configuration value of 3 may indicate that a third communication device serial port (e.g., serial port 3 (306)) is associated with a third subscription (e.g., subscription 3 (312)). The subscription configuration may also include a subscription configuration value of 0, which may indicate that a serial port is not associated with any subscription. In various embodiments, an indication that a serial port is not associated with any subscription may indicate that the serial port is independent of any subscription of the multi-subscription multi-standby device, and may be used to address any subscription of the multi-subscription multi-standby device.

FIG. 4C illustrates an exemplary information display 406 of enumerated serial ports and related descriptions according to the various embodiments. With reference to FIGS. 1-4C, a processor of a computing device (e.g., the computing device 108) may use the data structure of the subscription configuration 404 to generate the information display 406 illustrating enumerated serial ports of the computing device and corresponding descriptions, such as the association of each serial port to a subscription of a multi-subscription multi-standby communication device (e.g., the multi-subscription multi-standby communication device 106, 200). For example, a processor of the computing device may execute communication client software (such as the communication client software 108d), which may be configured to perform communications activities, such as voice communications and/or data communications, using the network communication capabilities of the connected multi-subscription multi-standby communication device.

The information display 406 may be generated by the processor of the computing device and displayed on a display (not shown) of the computing device, for example, as part of or related to the communication client software, to provide information to a user about the enumerated serial ports of the computing device and the corresponding subscriptions of the multi-subscription multi-standby communication device. In various embodiments, the information display 406 may provide a listing of enumerated serial ports of the computing device, for example, by a name of each serial port (i.e., a port name) and a related description of a subscription of the multi-subscription multi-standby communication device associated with each serial port, if any.

For example, the information display 406 may provide an indication that a first serial port, e.g., “<PORT NAME 0>”, is not associated with a subscription of the multi-subscription multi-standby communication device. As another example, the information display 406 may indicate that a second serial port, e.g., “<PORT NAME 2>”, is associated with a first subscription of the multi-subscription multi-standby communication device (e.g., the subscription 1 (308)), by an indication such as, for example, “#SUB1”, or any other indication of the association. As another example, the information display 406 may indicate that a third serial port, e.g., <PORT NAME 2>″, is associated with a second subscription of the multi-subscription multi-standby device (e.g., the subscription 2 (310)), by an indication such as, for example, “#SUB2”, or any other indication of the association. As a further example, the information display 406 may indicate that a fourth serial port, e.g., <PORT NAME 3>″, is associated with a second subscription of the multi-subscription multi-standby device (e.g., the subscription 3 (312)), by an indication such as, for example, “#SUB3”, or any other indication of the association. In various embodiments, the information display 406 of enumerated serial ports and related descriptions may be configured such that the communication client software may receive an input (e.g., from a user) indicating a port name and/or subscription of the multi-subscription multi-standby communication device to use for a communication session of the communication client software.

In various embodiments, the subscriptions of the multi-subscription multi-standby communication device may include voice subscriptions and/or data subscriptions associated with one or more communication networks. In various embodiments, the processor of the computing device may receive from a modem of the multi-subscription multi-standby communication device an indication of the type of subscriptions of the multi-subscription multi-standby communication device. In various embodiments, the processor of the computing device may receive from the modem of the multi-subscription multi-standby communication device an indication of a number of subscriptions of the multi-subscription multi-standby communication device. The processor of the computing device may use the indication of the type and/or number of subscriptions of the multi-subscription multi-standby communication device to associate serial ports of the computing device with subscriptions of the multi-subscription multi-standby communication device, and to generate the subscription configuration 404 and the information display 406.

In various embodiments, a serial port driver (e.g., the serial port driver 108b) and/or a connection manager (e.g., the connection manager 108c) of the computing device may use the enumerated virtual serial ports to address communications and/or commands to a specific subscription of the multi-subscription multi-standby communication device modem. In various embodiments, the processor of the computing device may assign each enumerated serial port an address or identifier to indicate its associated subscription of the multi-subscription multi-standby communication device, and the processor/serial port driver/connection manager may use the assigned address or identifier to send communications and/or commands to a specific subscription of the multi-subscription multi-standby communication device modem.

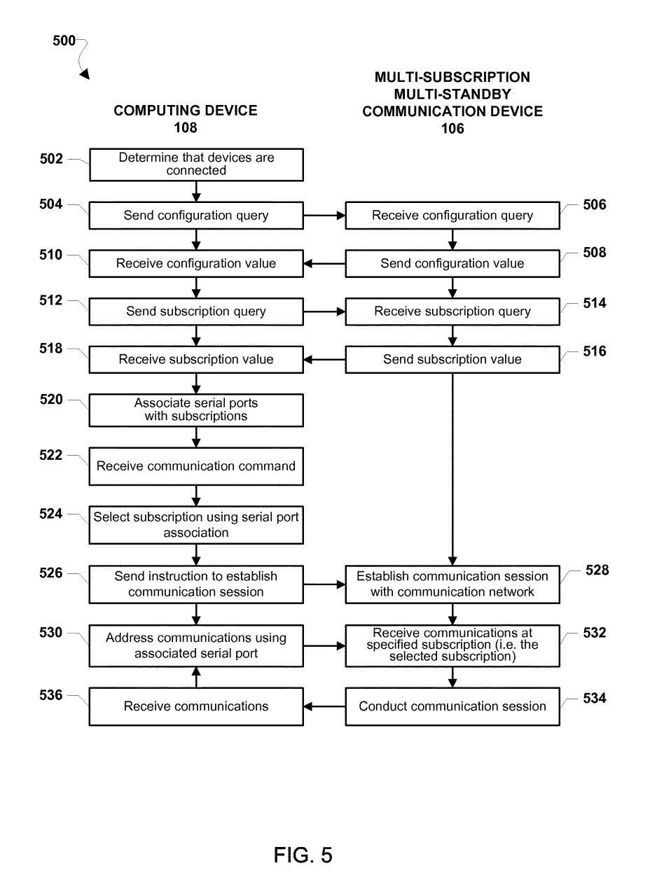

FIG. 5 illustrates a method 500 of serial port enumeration for communication via a multi-subscription multi-standby communication device according to various embodiments. With reference to FIGS. 1-5, the method 500 may be implemented by a processor of a computing device (e.g., a processor of the computing device 108) and a processor of the multi-subscription multi-standby communication device (e.g., the general purpose processor 206, the baseband modem processor 216, a separate controller, and/or the like) of a mobile communication device (e.g., the multi-subscription multi-standby communication device 200).

In block 502, the processor of the computing device may determine that the computing device and the multi-subscription multi-standby communication device are connected (e.g., by the connector 114).

In block 504, the processor of the computing device may send to the multi-subscription multi-standby communication device a configuration query. In various embodiments, the processor of the computing device may send the configuration query to the multi-subscription multi-standby communication device in response to determining that the two devices are connected. In various embodiments, the processor of the computing device may send the configuration query to the multi-subscription multi-standby communication device in response to the launching of, or an instruction from, communication software on the computing device (e.g., the communication client software 108d).

In various embodiments, the processor of the computing device may instruct a port driver (e.g., the port driver 108b) to query the processor of the multi-subscription multi-standby communication device (e.g., a modem driver of the multi-subscription multi-standby communication device.) The configuration query may request an indication of the type of subscriptions of the multi-subscription multi-standby communication device, such as a voice subscription and/or a data subscription. In block 506, the processor of the multi-subscription multi-standby communication device may receive the configuration query.

In block 508, the processor of the multi-subscription multi-standby communication device may send a configuration value to the computing device in response to the configuration query. In block 510, the processor of the computing device may receive the configuration value from the multi-subscription multi-standby communication device. In various embodiments, the configuration value may indicate one or more types of subscriptions of the multi-subscription multi-standby communication device, which the computing device may use to perform serial port enumeration.

In block 512, the processor of the computing device may send a subscription query to the multi-subscription multi-standby communication device, which the processor of the multi-subscription multi-standby communication device may receive in block 514.

In block 516, the processor of the multi-subscription multi-standby communication device may send a subscription value to the computing device in response to the subscription query. The processor of the computing device may receive the subscription value from the multi-subscription multi-standby communication device in block 518. In various embodiments, the subscription value may indicate a number of subscriptions of the multi-subscription multi-standby communication device, such as at least one of a number of voice subscriptions and a number of data subscriptions of the multi-subscription multi-standby communication device.

In block 520, the processor of the computing device may associate one or more serial ports of the computing device (e.g., the serial ports 108a, 308, 310, 312) with a different subscription of the multi-subscription multi-standby communication device (e.g., the subscriptions 308, 310, 312). The processor of the computing device may associate the serial port(s) with the subscription(s) during or as part of a process of serial port enumeration. In various embodiments, a port driver of the computing device (e.g., the port driver 108b) may enumerate the serial ports of the computing device. In various embodiments, the processor of the computing device may associate the one or more serial ports of the computing device with the different subscriptions of the multi-subscription multi-standby communication device using the configuration value and the subscription value. The serial ports of the computing device may be physical serial ports and/or virtual serial ports. In various embodiments, during or after the processor of the computing device associates the one or more serial ports of the computing device with the different subscriptions of the multi-subscription multi-standby communication device, the processor of the computing device may generate a data structure such as the subscription configuration 404, and may store the subscription configuration in a memory of the computing device.

In block 522, the computing device may receive a communication command. For example, the computing device may include communication client software (e.g., the communication client software 108d), which may be executed on a processor of the computing device and may be used to perform communications activities, such as voice communications and/or data communications. The communication client software may, as part of its operation, provide an information display of enumerated serial ports and related descriptions (e.g., the information display 406). The information display may be based on the subscription configuration 404. In various embodiments, the communication command may include an instruction to initiate a communication session via the multi-subscription multi-standby communication device using an indicated subscription of the multi-subscription multi-standby communication device.

In various embodiments, the information display may illustrate the association of each serial port of the computing device to a subscription of the multi-subscription multi-standby communication device. For example, the processor of the computing device may execute the communication client software, which may be configured to perform communications activities, such as voice communications and/or data communications, using the network communication capabilities of the connected multi-subscription multi-standby communication device. In various embodiments, the information display of enumerated serial ports and related descriptions may be configured such that the communication client software may receive an input (e.g., from a user) indicating a port name and/or subscription of the multi-subscription multi-standby communication device to use for a communication session of the communication client software.

In block 524, the processor of the computing device may select a subscription of the multi-subscription multi-standby communication device using the association of serial ports of the computing device to subscriptions of the multi-subscription multi-standby communication device. For example, the communication client software may communicate with a connection manager of the computing device (e.g., the connection manager 108c), and in response to receiving the communication command, the communication client software may instruct the connection manager to initiate a communication session using the selected subscription (i.e., to initiate a data or voice communication session).

In block 526, the processor of the computing device may send an instruction to the multi-subscription multi-standby communication device to establish a communication session using the selected subscription. In various embodiments, the connection manager of the computing device may use the subscription configuration (e.g., the subscription configuration 404) to address the instruction to a serial port of the computing device that is associated with the selected subscription. In various embodiments, the connection manager may open a modem port or COM port (i.e., a serial port) of the computing device and send the instruction to the multi-subscription multi-standby communication device via the opened modem port or COM port. In various embodiments, the connection manager may use the address of the serial port associated with the selected subscription to address commands to the selected subscription on the multi-subscription multi-standby communication device.

In various embodiments, the connection manager may send one or more AT commands to the multi-subscription multi-standby communication device by addressing the AT commands to the selected serial port of the computing device. In various embodiments, the connection manager may send the one or more AT commands to a modem of the multi-subscription multi-standby communication device by addressing the AT commands to the selected serial port of the computing device.

In block 528, the multi-subscription multi-standby communication device may establish the requested communication session with a communication network (e.g., the communication networks 102, 104) in response to the instruction to establish a communication session using the selected subscription.

In block 530, the processor of the computing device may send communications to a subscription of the multi-subscription multi-standby communication device 106 by addressing communications (i.e., outbound communications) using the associated serial port to specify the subscription to which the communications are addressed by the computing device (i.e., the selected subscription). In block 532, the processor of the multi-subscription multi-standby communication device may receive the communications from the computing device at the specified subscription (i.e., the selected subscription).

In block 534, the processor of the multi-subscription multi-standby communication device may conduct the communication session (i.e., may send and receive communications related to the communication session) with the communication network. Conducting the communication session may also include sending to the computing device any inbound communications to the computing device (e.g., to the communication client software).

In block 536, the processor of the computing device may receive the communications and may present the communications via the communication client software. The processor of the computing device may again address communications to the selected subscription of the multi-subscription multi-standby communication device using the associated serial port to send further communications to the communication network via the processor of the multi-subscription multi-standby communication device in block 530.

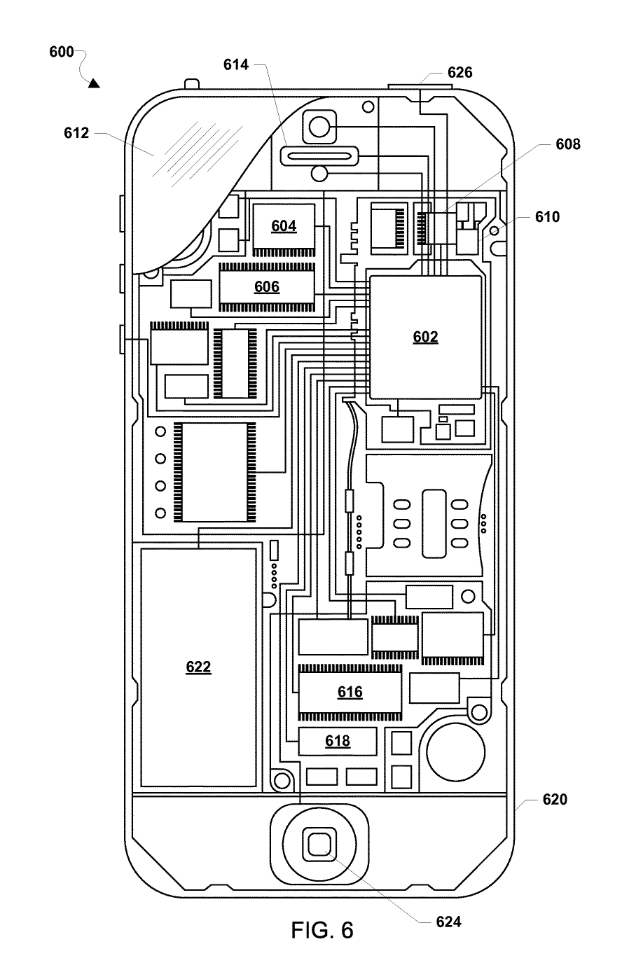

Various embodiments may be implemented in any of a variety of mobile communication devices, an example of which (e.g., mobile communication device 600) is illustrated in FIG. 6. In various embodiments, the mobile communication device 600 may be similar to the mobile communication devices 106 and 200 as described with reference to FIGS. 1-2. As such, the mobile communication device 600 may implement the method 500 of FIG. 5.

With reference to FIGS. 1-6, the mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile communication device 600 need not have touch screen capability.

The mobile communication device 600 may have two or more radio signal transceivers 608 (e.g., Peanut, Bluetooth, ZigBee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile communication device 600 may include one or more cellular network wireless modem chip(s) 616 coupled to the processor and antennae 610 that enables communication via two or more cellular networks via two or more radio access technologies.

The mobile communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

The mobile communication device 600 may also include speakers 614 for providing audio outputs. The mobile communication device 600 may also include a housing 620, constructed of a plastic, metal, or a combination of materials, for containing all or some of the components discussed herein. The mobile communication device 600 may include a power source 622 coupled to the processor 602, such as a disposable or rechargeable battery. The rechargeable battery may also be coupled to the peripheral device connection port to receive a charging current from a source external to the mobile communication device 600. The mobile communication device 600 may also include a physical button 624 for receiving user inputs. The mobile communication device 600 may also include a power button 626 for turning the mobile communication device 600 on and off.

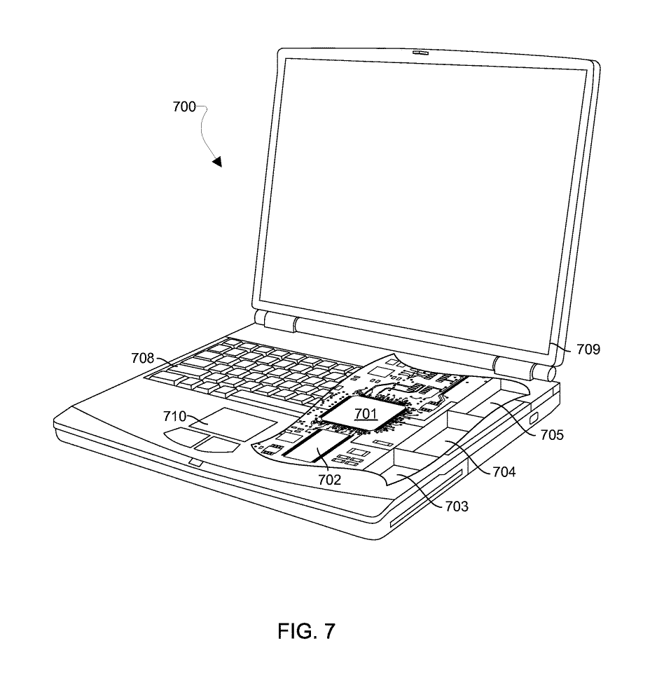

Various embodiments may also be implemented in any of a variety of computing devices, an example of which (e.g., computing device 700) is illustrated in FIG. 7. In various embodiments, the computing device 700 may be similar to the computing device 108 as described with reference to FIGS. 1 and 3. As such, the computing device 800 may implement the method 500 of FIG. 5.

With reference to FIGS. 1-7, the computing device 700 generally includes a processor 701 coupled to volatile memory 702 and a large capacity nonvolatile memory, such as a disk drive 703. The computer 700 may also include a compact disc (CD) and/or DVD drive 704 coupled to the processor 701. The computing device 700 may also include a number of connector ports coupled to the processor 701 for establishing data connections or receiving external memory devices, such as a network connection circuit 705 for coupling the processor 701 to a network. The computing device 700 may further be coupled to a keyboard 708, a pointing device such as a mouse 710, and a display 709 as is well known in the computer arts.

The processors 602 and 701 may be any programmable microprocessor, microcomputer or multiple processor chip or chips that can be configured by software instructions (applications) to perform a variety of functions, including the functions of various embodiments described below. In some devices, multiple processors 602 and 701 may be provided, such as one processor dedicated to wireless or wired communication functions and one processor dedicated to running other applications. Typically, software applications may be stored in the internal memory 606 and 702 before they are accessed and loaded into the processor 602 and 701. The processor 602 and 701 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

While the foregoing describes that a threshold may be met when a value is greater than or equal to the threshold, it will be appreciated that this is not a limitation, and that In some embodiments a threshold may be met when a value exceeds the threshold and not met when the value is less than or equal to the threshold.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method of serial port enumeration for communication via a multi-subscription multi-standby communication device executed by a processor of a computing device in communication with the multi-subscription multi-standby communication device, comprising:
associating each of two or more serial ports of the computing device with a different subscription of the multi-subscription multi-standby communication device; and
sending a communication to a subscription of the multi-subscription multi-standby communication device by addressing the communication to a serial port associated with the subscription.

2. The method of claim 1, wherein associating each of two or more serial ports of the computing device with a different subscription of the multi-subscription multi-standby communication device comprises:
sending to the multi-subscription multi-standby communication device a configuration query; and
receiving a configuration value from the multi-subscription multi-standby communication device in response to the configuration query.

3. The method of claim 2, wherein the configuration value comprises a type of subscription of the multi-subscription multi-standby communication device.

4. The method of claim 2, wherein the configuration value comprises at least one of voice subscriptions and data subscriptions.

5. The method of claim 2, wherein associating each of two or more serial ports of the computing device with a different subscription of the multi-subscription multi-standby communication device comprises associating each of two or more serial ports of the computing device with a different subscription of the multi-subscription multi-standby communication device based on the configuration value.

6. The method of claim 1, wherein associating each of two or more serial ports of the computing device with a different subscription of the multi-subscription multi-standby communication device comprises:
sending to the multi-subscription multi-standby communication device a subscription query; and
receiving a subscription value from the multi-subscription multi-standby communication device in response to the subscription query,
wherein the subscription value comprises a number of subscriptions of the multi-subscription multi-standby communication device.

7. The method of claim 6, wherein the subscription value comprises at least one of a number of voice subscriptions and a number of data subscriptions of the multi-subscription multi-standby communication device.

8. The method of claim 6, wherein associating each of two or more serial ports of the computing device with a different subscription of the multi-subscription multi-standby communication device comprises associating each of two or more serial ports of the computing device with a different subscription of the multi-subscription multi-standby communication device based on the subscription value.

9. The method of claim 1, wherein sending communications to a subscription of the multi-subscription multi-standby communication device by addressing the communication to the serial port associated with the subscription comprises selecting a subscription of the multi-subscription multi-standby communication device using an association of serial ports of the computing device to subscriptions of the multi-subscription multi-standby communication device.

10. The method of claim 1, wherein sending communications to a subscription of the multi-subscription multi-standby communication device by addressing the communication to the serial port associated with the subscription comprises sending, to the multi-subscription multi-standby communication device, an instruction to establish a communication session using the subscription of the multi-subscription multi-standby communication device by addressing the communication to the serial port associated with the subscription.

11. The method of claim 1, further comprising:
receiving communications from the multi-subscription multi-standby communication device according to a communication session conducted by the multi-subscription multi-standby communication device via the serial port associated with the subscription.

12. A computing device, comprising:
two or more serial ports; and
a processor coupled to the two or more serial ports, wherein the processor is configured to:
associate each of the two or more serial ports of the computing device with a different subscription of a multi-subscription multi-standby communication device in communication with the computing device; and
send a communication to a subscription of the multi-subscription multi-standby communication device by addressing the communication to one of the two or more serial ports associated with the subscription.

13. The computing device of claim 12, wherein the processor is further configured to:
send to the multi-subscription multi-standby communication device a configuration query; and
receive a configuration value from the multi-subscription multi-standby communication device in response to the configuration query.

14. The computing device of claim 13, wherein the processor is further configured such that the configuration value comprises a type of subscriptions of the multi-subscription multi-standby communication device.

15. The computing device of claim 13, wherein the processor is further configured such that the configuration value comprises at least one of voice subscriptions and data subscriptions.

16. The computing device of claim 13, wherein the processor is further configured to associate each of two or more serial ports of the computing device with a different subscription of the multi-subscription multi-standby communication device based on the configuration value.

17. The computing device of claim 12, wherein the processor is further configured to:
send to the multi-subscription multi-standby communication device a subscription query; and
receive a subscription value from the multi-subscription multi-standby communication device in response to the subscription query,
wherein the subscription value comprises a number of subscriptions of the multi-subscription multi-standby communication device.

18. The computing device of claim 17, wherein the processor is further configured such that the subscription value comprises at least one of a number of voice subscriptions and a number of data subscriptions of the multi-subscription multi-standby communication device.

19. The computing device of claim 17, wherein the processor is further configured to associate each of two or more serial ports of the computing device with a different subscription of the multi-subscription multi-standby communication device based on the subscription value.

20. The computing device of claim 12, wherein the processor is further configured to select a subscription of the multi-subscription multi-standby communication device using an association of serial ports of the computing device to subscriptions of the multi-subscription multi-standby communication device.

21. The computing device of claim 12, wherein the processor is further configured to send, to the multi-subscription multi-standby communication device, an instruction to establish a communication session using the subscription of the multi-subscription multi-standby communication device by addressing the communication to the serial port associated with the subscription.

22. The computing device of claim 12, wherein the processor is further configured to receive communications from the multi-subscription multi-standby communication device according to a communication session conducted by the multi-subscription multi-standby communication device via the serial port associated with the subscription.

23. A non-transitory processor-readable storage medium having stored thereon processor-executable instructions configured to cause a processor of a computing device having two or more serial ports and a processor to perform operations comprising:
associating each of the two or more serial ports of the computing device with a different subscription of a multi-subscription multi-standby communication device in communication with the computing device; and
sending a communication to a subscription of the multi-subscription multi-standby communication device by addressing the communication to a serial port associated with the subscription.

24. The non-transitory processor-readable storage medium of claim 23, wherein the stored processor-executable software instructions are configured to cause a processor to perform operations such that associating each of two or more serial ports of the computing device with a different subscription of the multi-subscription multi-standby communication device comprises:
sending to the multi-subscription multi-standby communication device a configuration query; and
receiving a configuration value from the multi-subscription multi-standby communication device in response to the configuration query.

25. The non-transitory processor-readable storage medium of claim 24, wherein the stored processor-executable software instructions are configured to cause a processor to perform operations such that the configuration value comprises a type of subscriptions of the multi-subscription multi-standby communication device.

26. The non-transitory processor-readable storage medium of claim 24, wherein the stored processor-executable software instructions are configured to cause a processor to perform operations such that the configuration value comprises at least one of voice subscriptions and data subscriptions.

27. A method of serial port enumeration for communication via a multi-subscription multi-standby communication device executed by a processor of the multi-subscription multi-standby communication device in communication with a computing device, comprising:
receiving a configuration query from the computing device;
sending a configuration value to the computing device in response to the configuration query;
establishing a communication session with a communication network in response to an instruction from the computing device to establish a communication session using a selected subscription of the multi-subscription multi-standby communication device;
receiving, from the computing device, communications at the selected subscription of the multi-subscription multi-standby communication device; and
conducting the communication session with the communication network using received communications.

28. The method of claim 27, further comprising:
receiving a subscription query from the computing device; and
sending a subscription value to the computing device in response to the subscription query.

29. The method of claim 28, wherein the subscription value comprises a number of subscriptions of the multi-subscription multi-standby communication device.

30. The method of claim 28, wherein the subscription value comprises at least one of a number of voice subscriptions and a number of data subscriptions of the multi-subscription multi-standby communication device.
